(19) United States
(12) Patent Application Publication
(10) Pub. No.: US 2026/0316555 A1
(43) Pub. Date: Oct. 15, 2026

(54) VEHICLE

(71) Applicant: ISUZU MOTORS LIMITED, Yokohama-shi (JP)

(72) Inventor: Ryu ODA, Bankok (TH)

(21) Appl. No.: 19/463,601

(22) Filed: Jan. 29, 2026

(30) Foreign Application Priority Data
Mar. 24, 2025 (JP) 2025-047721

(51) Int. Cl. B60K 13/04; F01N 13/08

(52) U.S. Cl. CPC B60K 13/04; F01N 13/082

(57) ABSTRACT

A vehicle includes a purification device that is positioned outward from a side frame in a vehicle width direction and purifies exhaust gas of an engine, and a tail pipe that is connected to the purification device and discharges the exhaust gas from a discharge outlet to the atmosphere. The tail pipe includes a coupling portion that is coupled to the purification device, a first bent portion that is bent from the coupling portion toward the center in the vehicle width direction, and a second bent portion that is bent outward in the vehicle width direction from the first bent portion and has the discharge outlet at a distal end thereof.

### CROSS-REFERENCE TO RELATED APPLICATIONS

The present application claims priority to Japanese Patent Applications number 2025-47721, filed on Mar. 24, 2025 contents of which are incorporated herein by reference in their entirety.

### BACKGROUND OF THE INVENTION

The present disclosure relates to a vehicle having a tail pipe.

Japanese Unexamined Patent Application Publication No. 2018-95131 discloses a tail pipe that discharges exhaust gas purified by a purification device in a direction toward the outside in a vehicle width direction. The tail pipe extends in a direction toward the outside in the vehicle width direction.

In the above-described tail pipe, a discharge outlet for discharging exhaust gas is positioned at a position separated outwardly in the vehicle width direction from a side frame. Therefore, heat of high-temperature exhaust gas discharged from the discharge outlet may adversely affect pedestrians or the like around the vehicle (hereinafter also referred to as thermal damage).

### BRIEF SUMMARY OF THE INVENTION

The present disclosure focuses on this point, and an object thereof is to suppress thermal damage caused by exhaust gas discharged from the tail pipe.

An aspect of the present disclosure provides a vehicle including a purification device that is positioned outward from a side frame in a vehicle width direction and purifies exhaust gas of an engine, and a tail pipe that is connected to the purification device and discharges the exhaust gas from a discharge outlet to the atmosphere, wherein the tail pipe includes a coupling portion that is coupled to the purification device, a first bent portion that is bent from the coupling portion toward the center in the vehicle width direction, and a second bent portion that is bent outward in the vehicle width direction from the first bent portion and has the discharge outlet at a distal end thereof.

### BRIEF DESCRIPTION OF THE DRAWINGS

FIG. 1 schematically shows a configuration of a vehicle 1 according to an embodiment.

FIG. 2 schematically shows a configuration of an exhaust passage 20.

FIG. 3 is a schematic side view of a downstream aftertreatment unit 26 and a tail pipe 30.

FIG. 4 is a schematic view illustrating exhaust gas discharged from a discharge outlet 31 of the tail pipe 30.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of Vehicle

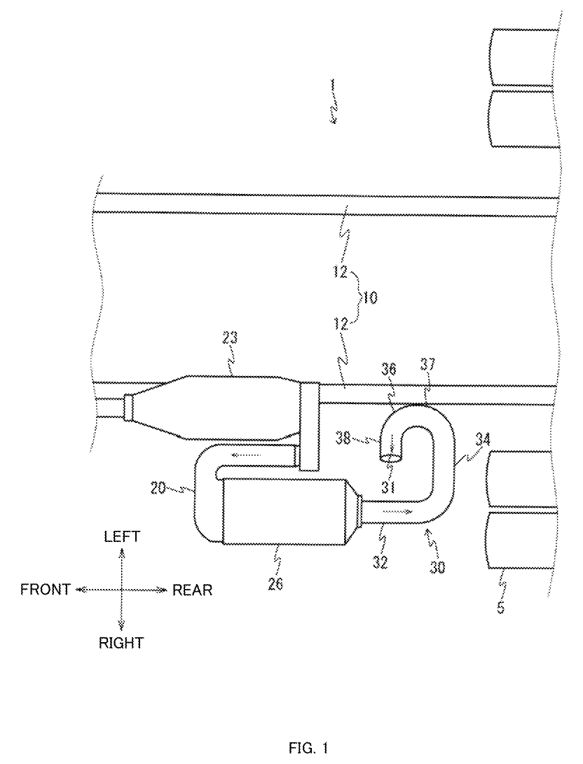

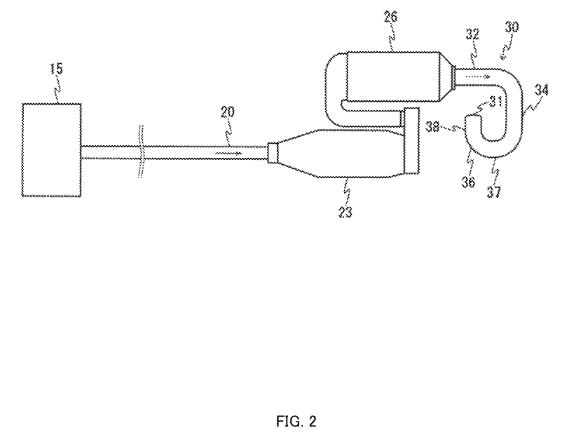

FIG. 1 schematically shows a configuration of a vehicle 1 according to an embodiment. FIG. 2 schematically shows a configuration of an exhaust passage 20. FIG. 1 shows a configuration of a vehicle body frame 10 and the like as viewed from a lower side of the vehicle 1. In FIG. 1, arrows indicate the front-rear direction and the vehicle width direction of the vehicle 1.

The vehicle 1 is a cab-over type truck, for example. The vehicle 1 includes the vehicle body frame 10, an engine 15, an exhaust passage 20, an upstream aftertreatment unit 23, a downstream aftertreatment unit 26, and a tail pipe 30.

The vehicle body frame 10 is a chassis frame that forms a frame for supporting the vehicle 1. The vehicle body frame 10 includes a pair of side frames 12 extending in the front-rear direction of the vehicle 1, and a cross member provided along the vehicle width direction and coupled to the pair of side frames 12.

The engine 15 is an internal combustion engine that generates power by combusting and expanding a mixture of fuel and intake air. The engine 15 is a diesel engine, for example. The engine 15 is supported on a front side of the side frame 12 in the front-rear direction.

As shown in FIG. 2, the exhaust passage 20 is an exhaust pipe connected to the engine 15. Exhaust gas discharged from the engine 15 flows through the exhaust passage 20. The exhaust passage 20 extends rearward from the front side of the side frame 12. The exhaust passage 20 includes all exhaust pipes connecting the engine 15 and the tail pipe 30. Further, the exhaust passage 20 is provided with the upstream aftertreatment unit 23 and the downstream aftertreatment unit 26.

The upstream aftertreatment unit 23 and the downstream aftertreatment unit 26 are purification devices that purify exhaust gas as aftertreatment for exhaust gas flowing through the exhaust passage 20.

The upstream aftertreatment unit 23 includes a Diesel Particulate Filter (DPF), which is a filter that collects Particulate Matter (PM) contained in exhaust gas. The DPF is formed of a honeycomb body made of metal or ceramics, for example, and collects PM by pores and surfaces of partition walls. The upstream aftertreatment unit 23 is supported by the side frame 12 via a bracket.

The downstream aftertreatment unit 26 includes a Selective Catalytic Reduction (SCR) catalyst, which is a reduction catalyst that promotes a reduction reaction between ammonia and NOx. Ammonia generated from urea water injected into the exhaust passage 20 from an injection unit is adsorbed to the SCR catalyst. The SCR catalyst reduces NOx to harmless nitrogen and water by adsorbed ammonia, thereby reducing emission of NOx in exhaust gas. The downstream aftertreatment unit 26 is supported by the side frame 12 via a bracket.

The downstream aftertreatment unit 26 is positioned outward from the side frame 12 in the vehicle width direction. Specifically, as shown in FIG. 1, the downstream aftertreatment unit 26 is positioned on a right side of the side frame 12 in the vehicle width direction. Further, the downstream aftertreatment unit 26 is provided in parallel with the side frame 12. A rear wheel 5 is positioned rearward of the downstream aftertreatment unit 26 in the front-rear direction.

The tail pipe 30 is a cylindrical pipe provided at the downstream end of the exhaust passage 20, and is coupled to the downstream aftertreatment unit 26. The tail pipe 30 is positioned on the right side of the side frame 12 in the vehicle width direction, similarly to the downstream aftertreatment unit 26. The tail pipe 30 is positioned near the rear wheel 5 of the vehicle 1.

The tail pipe 30 discharges exhaust gas from the discharge outlet 31 to the atmosphere. Specifically, the tail pipe 30 discharges exhaust gas to the right side in the vehicle width direction when viewed from the side frame 12. It should be noted that the temperature of exhaust gas discharged from the tail pipe 30 tends to decrease as the length of the tail pipe 30 increases.

In the above description, the downstream aftertreatment unit 26 and the tail pipe 30 are positioned on the right side of the side frame 12 in the vehicle width direction, but the positioning is not limited thereto. For example, the downstream aftertreatment unit 26 and the tail pipe 30 may be positioned on a left side of the side frame 12 in the vehicle width direction. In this case, the tail pipe 30 discharges exhaust gas to the left side in the vehicle width direction. Accordingly, it can be said that the tail pipe 30 discharges exhaust gas toward an outer side of the side frame 12 in the vehicle width direction.

Depending on the orientation of the discharge outlet 31 of the tail pipe 30, thermal damage may occur due to exhaust gas discharged from the discharge outlet 31. For example, when exhaust gas discharged from the discharge outlet 31 is directed toward a tire of the rear wheel 5, the tire of the rear wheel 5 may deteriorate due to heat of the exhaust gas. When an operator or a pedestrian (hereinafter also referred to as a pedestrian or the like) is present around the vehicle 1, exhaust gas discharged from the discharge outlet 31 may affect the pedestrian or the like.

In contrast, in the present embodiment, the tail pipe 30 has a structure capable of suppressing the occurrence of thermal damage caused by exhaust gas.

### Detailed configuration of tail pipe

A detailed configuration of the tail pipe 30 will be described with reference to FIGS. 1-4.

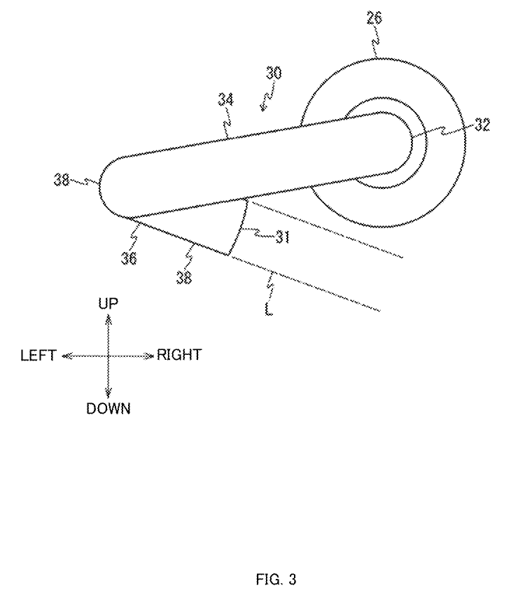

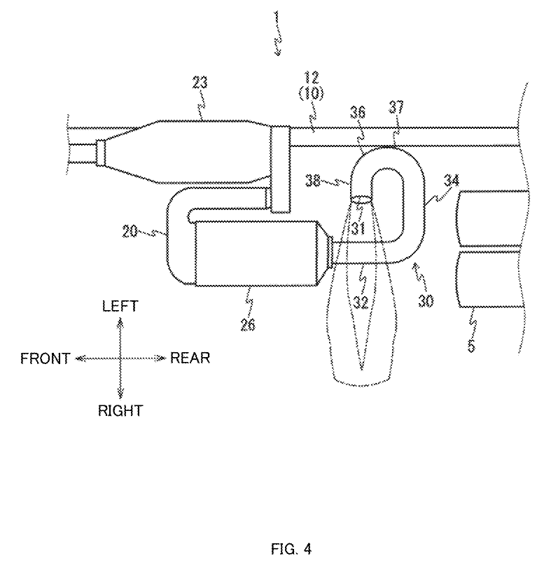

FIG. 3 is a schematic side view of the downstream aftertreatment unit 26 and the tail pipe 30. FIG. 4 is a schematic view illustrating exhaust gas discharged from the discharge outlet 31 of the tail pipe 30.

In the present embodiment, the tail pipe 30 has a bent shape as shown in FIG. 1 rather than a straight shape. The tail pipe 30 includes a coupling portion 32, a first bent portion 34, and a second bent portion 36.

The coupling portion 32 is an upstream cylindrical portion of the tail pipe 30 and is coupled to the downstream aftertreatment unit 26. Therefore, exhaust gas that has passed through the downstream aftertreatment unit 26 flows through the coupling portion 32. As shown in FIG. 1, the coupling portion 32 is disposed parallel to the front-rear direction of the vehicle 1 along the side frame 12. The coupling portion 32 is positioned between the downstream aftertreatment unit 26 and the rear wheel 5. Specifically, the coupling portion 32 is positioned closer to the rear wheel 5 than the downstream aftertreatment unit 26. Further, the downstream aftertreatment unit 26, the coupling portion 32, and the rear wheel 5 are arranged in the front-rear direction of the vehicle 1 so as to be positioned on the same line.

The first bent portion 34 is a cylindrical portion connected to the coupling portion 32, and is bent toward the center in the vehicle width direction from the coupling portion 32 as shown in FIG. 1. For example, the first bent portion 34 is bent so as to be orthogonal to the coupling portion 32. For example, it is assumed that the first bent portion 34 is bent at a predetermined curvature. Therefore, the first bent portion 34 is positioned parallel to the vehicle width direction of the vehicle 1. By providing the first bent portion 34, exhaust gas that has passed through the coupling portion 32 flows toward the center in the vehicle width direction.

The second bent portion 36 is a downstream cylindrical portion of the tail pipe 30 and is connected to the first bent portion 34. The second bent portion 36 is bent outward in the vehicle width direction from the first bent portion 34. For example, it is assumed that the second bent portion 36 is bent at a predetermined curvature. Specifically, the second bent portion 36 is bent outward in the vehicle width direction from the first bent portion 34. More specifically, the second bent portion 36 is bent to form a U-shape as shown in FIG. 1.

The second bent portion 36 has the discharge outlet 31 at its distal end. Since the second bent portion 36 is bent outward in the vehicle width direction, exhaust gas flowing through the second bent portion 36 is discharged from the discharge outlet 31 toward an outer side in the vehicle width direction. Specifically, as shown in FIG. 4, exhaust gas is discharged from the discharge outlet 31 in a direction parallel to the vehicle width direction. Accordingly, exhaust gas discharged from the discharge outlet 31 does not flow toward the rear wheel 5, thereby suppressing thermal damage to the tire of the rear wheel 5 caused by the exhaust gas.

As shown in FIG. 1, the discharge outlet 31 is positioned closer to the center in the vehicle width direction than the coupling portion 32. Specifically, the discharge outlet 31 is positioned closer to the center in the vehicle width direction than the downstream aftertreatment unit 26. Further, the discharge outlet 31 may be positioned closer to the center in the vehicle width direction than an intermediate position between the coupling portion 32 and the side frame 12. Since the discharge outlet 31 is positioned closer to the center in the vehicle width direction than the coupling portion 32 as described above, a high-temperature region of exhaust gas discharged from the discharge outlet 31 can be brought closer to the side frame 12 than in the case where the discharge outlet 31 is positioned outward from the coupling portion 32 in the vehicle width direction (see FIG. 4). As a result, when a pedestrian or the like is present around the vehicle 1, thermal damage to the pedestrian or the like caused by exhaust gas can be suppressed.

The second bent portion 36 has an intermediate portion 37 and a distal end portion 38.

A part of the intermediate portion 37 is connected to the first bent portion 34, and is bent along the side frame 12 from the first bent portion 34. A part of the intermediate portion 37 is provided so as to be orthogonal to the first bent portion 34, and is parallel to the front-rear direction of the vehicle 1. Further, the intermediate portion 37 is adjacent to the side frame 12 of the vehicle body frame 10.

The intermediate portion 37 extends toward the downstream aftertreatment unit 26 when viewed from the first bent portion 34 in the front-rear direction. In other words, the intermediate portion 37 extends forward in the front-rear direction. Therefore, the tail pipe 30 can be arranged to have an increased length within a short range in the front-rear direction. As a result, the total length of the tail pipe 30 through which exhaust gas flows is increased, the temperature of exhaust gas when discharged from the discharge outlet 31 tends to decrease, and thermal damage caused by the exhaust gas can be suppressed.

It should be noted that, in the above description, the intermediate portion 37 extends forward in the front-rear direction when viewed from the first bent portion 34, but the extension direction is not limited thereto. For example, the intermediate portion 37 may extend rearward in the front-rear direction as viewed from the first bent portion 34 in the front-rear direction.

The discharge outlet 31 is formed at the distal end portion 38. The distal end portion 38 is a portion connected to the intermediate portion 37, and is bent outward in the vehicle width direction from the intermediate portion 37. Specifically, the distal end portion 38 is bent along the vehicle width direction from the intermediate portion 37. More specifically, the distal end portion 38 is parallel to the vehicle width direction. Accordingly, exhaust gas discharged from the discharge outlet 31 of the distal end portion 38 can be prevented from flowing toward the rear wheel 5.

As shown in FIG. 1, the distal end portion 38 is spaced apart from the downstream aftertreatment unit 26 in the front-rear direction of the vehicle 1. Specifically, the distal end portion 38 is positioned between the downstream aftertreatment unit 26 and the first bent portion 34 in the front-rear direction. As a result, exhaust gas discharged from the discharge outlet 31 is less likely to come into contact with the downstream aftertreatment unit 26, thereby suppressing the occurrence of thermal damage in the downstream aftertreatment unit 26 caused by the exhaust gas.

As shown in FIG. 3, the distal end portion 38 is inclined downward in the vertical direction. An inclination degree of the distal end portion 38 is set so that exhaust gas discharged from the discharge outlet 31 does not contact the coupling portion 32. Specifically, the distal end portion 38 is inclined downward so that an imaginary line (an imaginary line L shown in FIG. 3) obtained by extending an outline of the discharge outlet 31 in a normal direction of a plane including the discharge outlet 31 passes through a region spaced apart from the coupling portion 32 and the first bent portion 34.

Unlike in the present embodiment, if exhaust gas discharged from the discharge outlet 31 comes into contact with the coupling portion 32, the temperature of exhaust gas flowing through the coupling portion 32 may increase, and the temperature of exhaust gas discharged from the discharge outlet 31 may increase.

In contrast, when the distal end portion 38 is inclined as described above as in the present embodiment, exhaust gas discharged from the discharge outlet 31 does not come into contact with the coupling portion 32, and an increase in the temperature of the exhaust gas in the coupling portion 32 caused by the discharged exhaust gas can be suppressed. In addition, when the distal end portion 38 is inclined downward in the vertical direction, exhaust gas discharged from the discharge outlet 31 is directed to the road surface, thereby suppressing exhaust gas from being directed to a pedestrian or the like around the vehicle 1.

However, the present disclosure is not limited thereto, and the distal end portion 38 may be inclined upward in the vertical direction. Also in this case, exhaust gas discharged from the discharge outlet 31 does not come into contact with the coupling portion 32, thereby suppressing an increase in the temperature of the exhaust gas flowing in the coupling portion 32.

Further, in the above description, the first bent portion 34 and the second bent portion 36 include straight portions, but the present disclosure is not limited thereto. For example, the first bent portion 34 and the second bent portion 36 may have no straight portion and may be bent at a predetermined curvature. In this case, since the tail pipe 30 is not sharply bent, the pressure loss of exhaust gas passing through the first bent portion 34 and the second bent portion 36 can be suppressed.

In the above description, although the first bent portion 34 and the second bent portion 36 are bent with a predetermined curvature, the present disclosure is not limited thereto. For example, in the first bent portion 34 and the second bent portion 36, the cylindrical exhaust pipes may be connected with an angle therebetween. In addition, each portion of the tail pipe 30 may be partially or entirely formed of a rectangular pipe instead of a cylindrical pipe.

### Effects of the embodiment

The vehicle 1 of the above-described embodiment includes the tail pipe 30 connected to the downstream aftertreatment unit 26. The tail pipe 30 includes i) the coupling portion 32 that is coupled to the downstream aftertreatment unit 26, ii) the first bent portion 34 that is bent toward the center in the vehicle width direction from the coupling portion 32, and iii) the second bent portion 36 that is bent outward in the vehicle width direction from the first bent portion 34 and has the discharge outlet 31 at its distal end.

Accordingly, since exhaust gas is discharged from the discharge outlet 31 toward the outer side in the vehicle width direction, the exhaust gas is suppressed from flowing toward the rear wheel 5, and thus it is possible to suppress thermal damage to the rear wheel 5 caused by the exhaust gas. In addition, since the total length of the tail pipe 30 can be increased even in a narrow region in the front-rear direction by providing the tail pipe 30 with the first bent portion 34 and the second bent portion 36, it is possible to lower the temperature of exhaust gas discharged from the discharge outlet 31, and as a result, it is possible to suppress thermal damage caused by the exhaust gas.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A vehicle comprising:
a purification device that is positioned outward from a side frame in a vehicle width direction and purifies exhaust gas of an engine; and
a tail pipe that is connected to the purification device and discharges the exhaust gas from a discharge outlet to the atmosphere, wherein
the tail pipe includes:
a coupling portion that is coupled to the purification device,
a first bent portion that is bent from the coupling portion toward the center in the vehicle width direction, and
a second bent portion that is bent outward in the vehicle width direction from the first bent portion and has the discharge outlet at a distal end thereof.

2. The vehicle according to claim 1, wherein
the discharge outlet is positioned closer to the center in the vehicle width direction than the coupling portion.

3. The vehicle according to claim 2, wherein
the discharge outlet is positioned closer to the center in the vehicle width direction than an intermediate position between the coupling portion and the side frame.

4. The vehicle according to claim 1, wherein
the second bent portion includes a distal end portion having the discharge outlet, and
the distal end portion is parallel to the vehicle width direction.

5. The vehicle according to claim 1, wherein
an imaginary line obtained by extending an outline of the discharge outlet in a normal direction of a plane including the discharge outlet passes through a region spaced apart from the coupling portion and the first bent portion.

6. The vehicle according to claim 1, wherein
the second bent portion includes a distal end portion having the discharge outlet, and
the distal end portion is inclined downward in a vertical direction.

7. The vehicle according to claim 1, wherein
the second bent portion includes:
an intermediate portion that is bent along the side frame from the first bent portion, and
a distal end portion that is bent outward in the vehicle width direction from the intermediate portion and has the discharge outlet.

8. The vehicle according to claim 7, wherein
the distal end portion is positioned between the first bent portion and the purification device in the front-rear direction of the vehicle.

9. The vehicle according to claim 1, further comprising:
a rear wheel that is positioned rearward of the purification device in the front-rear direction, wherein
the purification device, the coupling portion, and the rear wheel are positioned on the same line in the front-rear direction.

10. The vehicle according to claim 1, wherein
the first bent portion and the second bent portion are bent at a predetermined curvature.
